(19) United States
(12) Patent Application Publication
(10) Pub. No.: US 2024/0308626 A1
(43) Pub. Date: Sep. 19, 2024

(54) Method for making paddle board

(71) Applicant: Aifu Shen, Ningbo (CN)

(72) Inventor: Aifu Shen, Ningbo (CN)

(21) Appl. No.: 18/676,454

(22) Filed: May 28, 2024

(30) Foreign Application Priority Data
Aug. 29, 2023 (CN) 202311100362.3

(51) Int. Cl. B63B 32/50; B63B 32/57; B63B 32/59

(52) U.S. Cl. CPC B63B 32/50; B63B 32/57; B63B 32/59

(57) ABSTRACT

A method for making a paddle board includes steps of: 1) bonding a lower protective layer and an upper protective layer to a core board, and trimming edges of the upper protective layer so that the edges of the upper protective layer are flatly adhered to edges of the lower protective layer; and 2) arranging a concave portion in a middle position of a top surface of the paddle board, and embedding a handle in the concave portion for carrying the paddle board; wherein a cavity, which is configured to be inserted with fingers, is provided in a middle of the handle. The handle has a long service life as well as a good gripping effect, and prevents fingers from slipping off. The paddle board has a good waterproof performance, a good impact resistance, and a long service life.

### CROSS REFERENCE OF RELATED APPLICATION

The present invention claims priority under 35 U.S.C. 119(a-d) to CN 202311100362.3, filed Aug. 29, 2023.

### BACKGROUND OF THE PRESENT INVENTION

### Field of Invention

The present invention relates to a technical field of making paddle boards, and more particularly to a method for making a paddle board.

### Description of Related Arts

A paddle board is large in size. If a user wants to carry the paddle board under his armpit, he will find that his hand cannot reach the side wall of the paddle board. Therefore, it is necessary to set up a handle in the middle of the paddle board, so as to hold and carry it.

Chinese patent application CN202320226755.8, Water Sports Board, disclosed a paddle board, comprising: a board body, wherein the board body comprises a foam core, a fiberglass upper layer wrapped around a top surface of the foam core, a fiberglass lower layer wrapped around a bottom surface of the foam core, and paint layers sprayed on external surfaces of the fiberglass upper layer and the fiberglass lower layer; wherein the fiberglass upper layer and the fiberglass lower layer are adhered to the foam core with resin; and an air hole is provided on a top surface of the board body, which is connected to the foam core. The advantage of the disclosure is that: the surfaces of the foam core of the board body are wrapped with the fiberglass layers, which improves toughness and strength of the board body, so that the board body is sturdy and durable, corrosion-resistant, and the service life of the board body is effectively prolonged. At the same time, the air hole is arranged on the top surface of the board body, which ensures air permeability of the foam core as well as avoids bulging and deformation of the board body. However, production of the handle of the paddle board is inefficient, and service life of the handle is short. When gripping the handle, it is easy to slip off due to a flat internal wall of the handle, leading to insufficient gripping effect. Therefore, the method for making the paddle board needs to be further improved.

### SUMMARY OF THE PRESENT INVENTION

In response to the above defects in the prior art, an object of the present invention is to provide a method for making a paddle board that is durable, impact resistant and easy to clip up and carry.

Accordingly, in order to accomplish the above objects, the present invention provides: a method for making a paddle board, wherein the paddle board comprises an upper protective layer, a lower protective layer and a core board; wherein the core board is sandwiched between the upper protective layer and lower protective layer; wherein the method comprises steps of:
1) bonding the lower protective layer to a bottom surface of the core board, then bonding the upper protective layer to a top surface of the core board, and trimming edges of the upper protective layer so that the edges of the upper protective layer are flatly adhered to edges of the lower protective layer; and
2) arranging a concave portion in a middle position of a top surface of the paddle board, and embedding a handle in the concave portion for carrying the paddle board; wherein a top opening of the handle is flush with a surface of the upper protective layer; the handle is a rigid handle molded by injection molding of ABS plastic, APD plastic, nylon, or nylon blends; and a cavity, which is configured to be inserted with fingers, is provided in a middle of the handle.

Preferably, continuous waveform concave portions, which fit the fingers, are arranged on two internal sides of the cavity of the handle along a length direction of the paddle board.

Preferably, the method further comprises steps of:
a) forming the core board by foaming a foam material in a core board mold with a desired shape, and leaving the concave portion for embedding the handle in a middle of the core board;
b) forming the lower protective layer by making a lower substrate with the foam material and affixing a transparent bottom sheet on a bottom surface of the lower substrate with an adhesive; and providing an internal pattern layer on an internal surface of the transparent bottom sheet through laser lining printing; and
c) forming the upper protective layer by making an upper substrate with the foam material and affixing a top sheet to a top surface of the upper substrate with an adhesive; then providing a surface pattern layer on an external surface of the top sheet through laser surface printing; and leaving a notch in a middle of the upper protective layer for embedding the handle.

Preferably, sidewall concave portions, which are configured to be pressed against by bent fingers, are also provided on the internal sides of the cavity where the continuous waveform concave portions locate; the sidewall concave portions are topped by a slope surface transitioning with the continuous waveform concave portions.

Preferably, the handle is box-shaped, and an external wall projection enabling an interference fit between the handle and the concave portion is formed on an external wall of the handle; the external wall projection is integrated with the handle through injection molding.

Preferably, a convex rim is provided on a top edge of the handle, and a top groove for engaging with the convex rim is formed at an opening of the concave portion.

Preferably, a width of the notch is smaller than a width of an opening of the top groove; the upper protective layer corresponding to the notch is sandwiched between the convex rim and a bottom surface of the top groove.

Preferably, a top surface of the convex rim is flush with a top surface of the upper protective layer which is exposed outside the convex rim.

Preferably, threaded holes are provided at intervals on a bottom surface of the cavity of the handle, and threaded connection holes are provided on a bottom surface of the concave portion corresponding to the threaded holes; the handle and the core plate are fixed together by screws.

Preferably, the lower protective layer and the upper protective layer are bonded to corresponding surfaces of the core board by a hot-melt adhesive; a wooden stiffener is embedded in the middle of the core board along the length direction of the paddle board.

Compared with the prior art, the present invention has the following advantages: the handle is a rigid handle molded by injection molding of ABS plastic, APD plastic, nylon, or nylon blends, wherein the injection molding efficiency is high, which accelerates the production efficiency of the handle. Furthermore, the rigid structure is robust and durable, so as to prolong the service life of the handle. The continuous waveform concave portions are arranged on two internal sides of the handle along a length direction of the paddle board, which fit the fingers and increases friction, providing better gripping effect as well as preventing slipping off. The sidewall concave portions are also provided on the internal sides of the handle where the continuous waveform concave portions locate, wherein a width of the cavity of the handle is larger than a width of the opening of the handle, and the fingers that are inserted into the cavity of the handle can be bent and then press against the internal wall of the handle. As a result, the palm is hook-shaped, which can easily hook the handle, proving ideal gripping effect. The sidewall concave portions are topped by a slope surface transitioning with the continuous waveform concave portions, thereby avoiding choking the fingers and providing better user experience. The handle is fixed with the paddle board through threaded holes in the middle of the bottom surface of the handle, making it easy to attach and detach. The lower protective layer together with the upper protective layer can improve the waterproof performance and impact resistance of the paddle board. The three-layer structure is bonded to each other to make it more durable, prolonging the service life of the paddle board. At the same time, pattern layers are provided on both the lower and upper protective layers, which are more beautiful and practical. The pattern of the lower protective layer is realized by laser lining printing, which means the pattern does not come into direct contact with the outside world, thereby reducing the direct wear and tear of the pattern layer, extending the service life of the pattern layer of the lower protective layer, and maintaining the integrity of the pattern for a longer period of time. The pattern on the upper protective layer can be internally or externally printed, depending on the requirements of the products, such as ski or surfboard products. The paddle board adopts a spindle-like structure, which increases the streamline as well as the wind and wave resistance.

### BRIEF DESCRIPTION OF THE DRAWINGS

FIG. 1 is a perspective view of an embodiment of the present invention;

FIG. 2 is an exploded view of FIG. 1;

FIG. 3 is a top view of FIG. 1;

FIG. 4 is a cross-sectional view of FIG. 3 along A-A;

FIG. 5 is a cross-sectional view of FIG. 3 along B-B;

FIG. 6 is an alternative exploded view of FIG. 1;

FIG. 7 is an exploded view of a structure in FIG. 6 after rotation;

FIG. 8 is a cross-sectional view of a handle in FIG. 6;

FIG. 9 is a partial enlarged view of part I in FIG. 4;

FIG. 10 is a partial enlarged view of part II in FIG. 4;

FIG. 11 is a partial enlarged view of part III in FIG. 5;

FIG. 12 is a partial enlarged view of part IV in FIG. 6;

FIG. 13 is a partial enlarged view of part V in FIG. 7; and

FIG. 14 is a partial enlarged view of part VI in FIG. 13.

### DETAILED DESCRIPTION OF THE PREFERRED EMBODIMENT

The present invention will be further described below in conjunction with embodiments of the accompanying drawings.

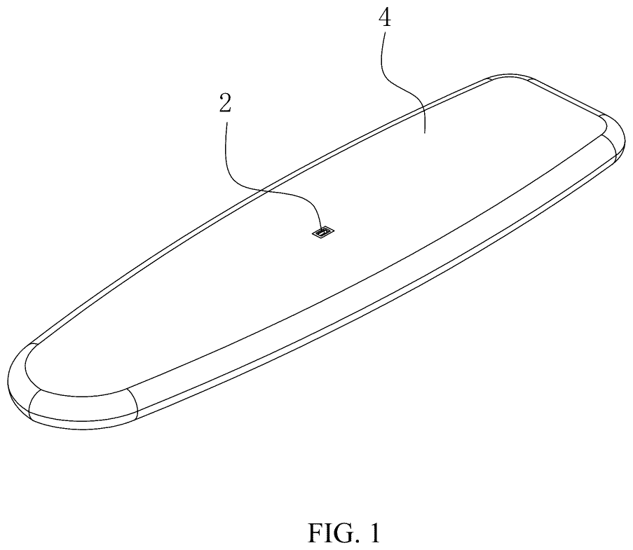

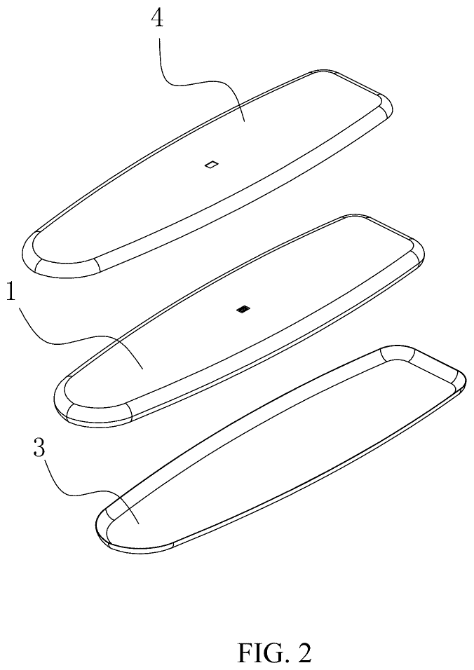

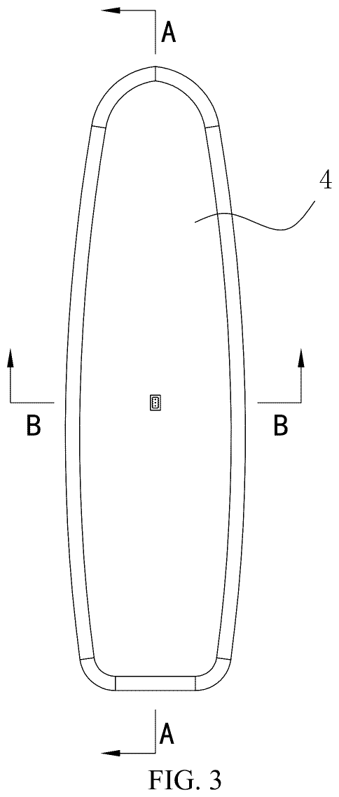

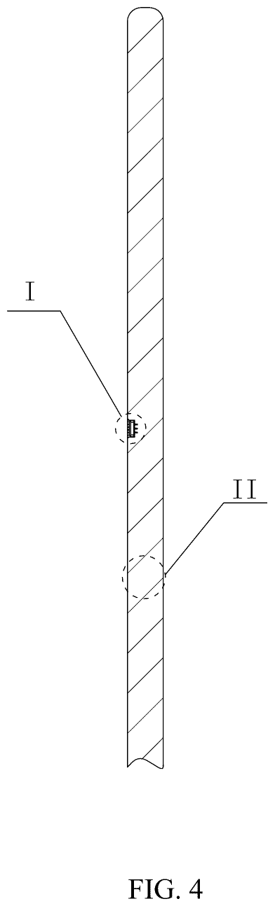

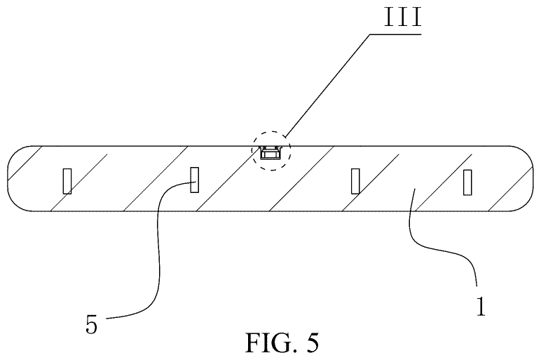

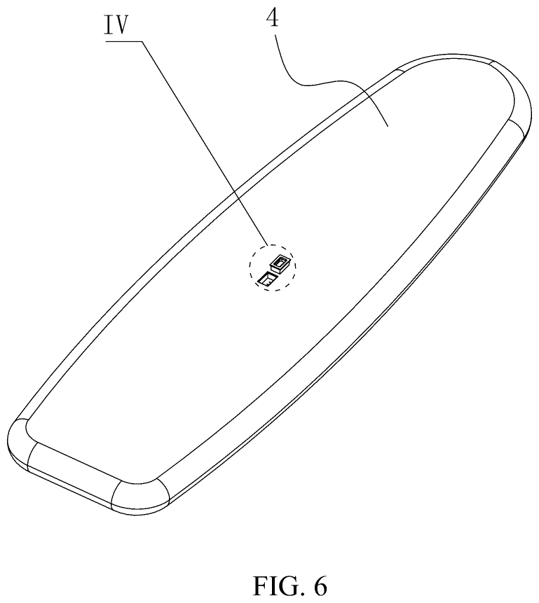

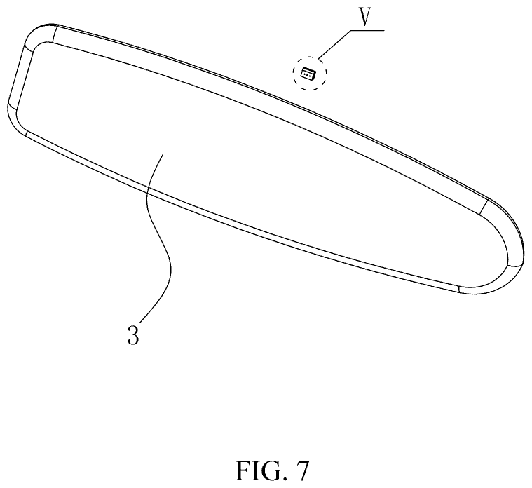

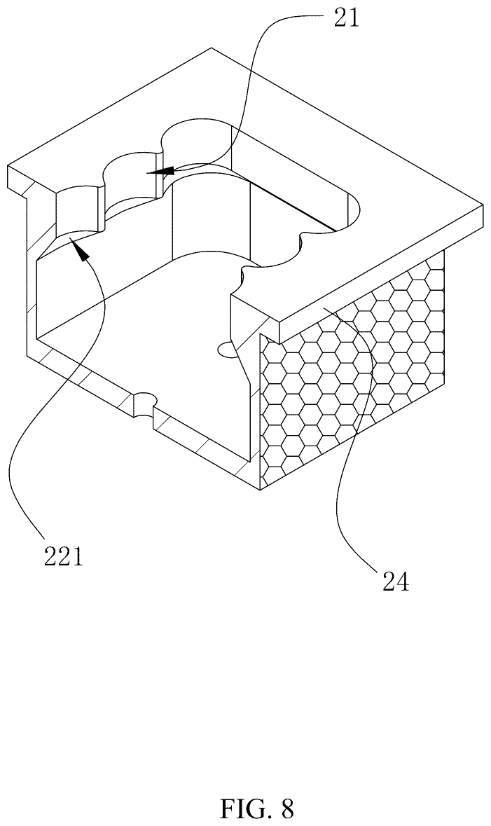

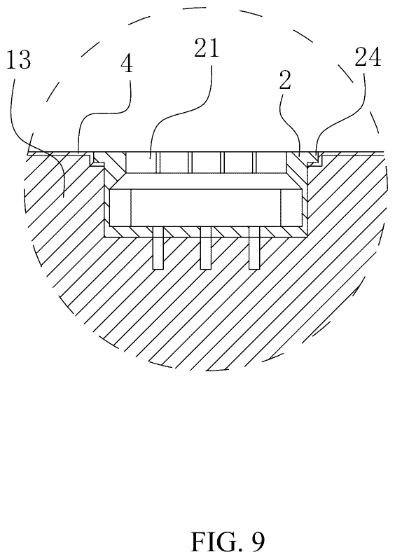

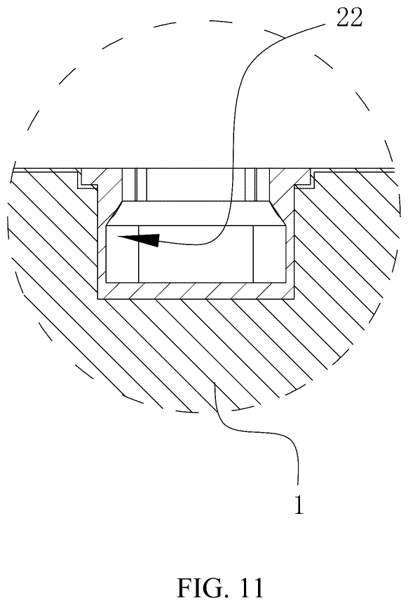

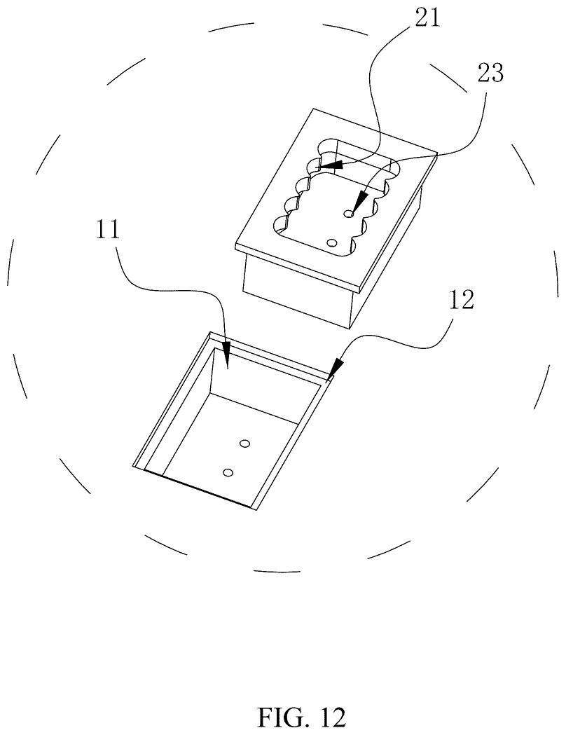

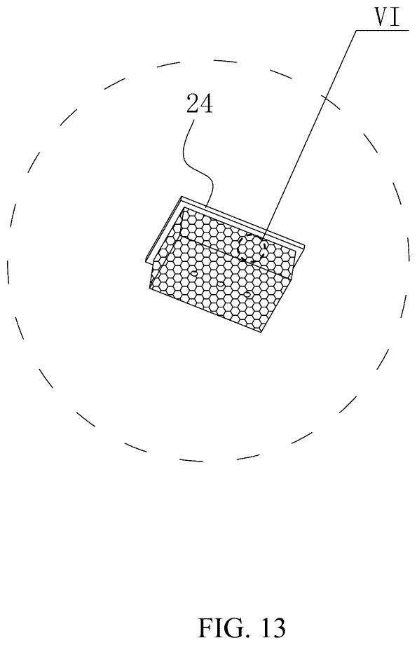

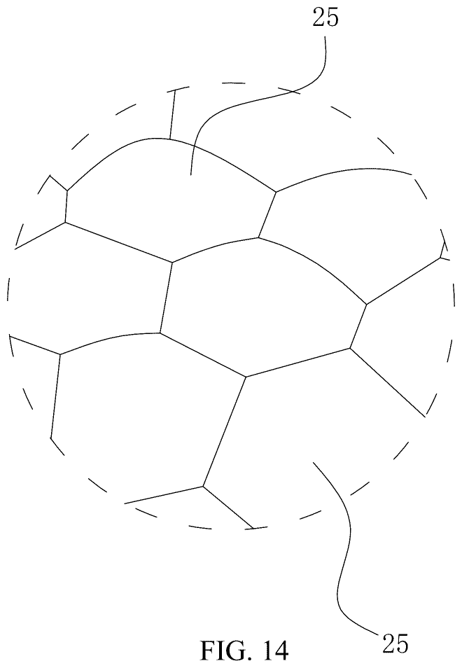

Referring to FIGS. 1-14, a paddle board according to an embodiment of the present invention comprises an upper protective layer 4, a lower protective layer 3 and a core board 1; wherein the core board 1 is sandwiched between the upper protective layer 4 and lower protective layer 3. A method for making the paddle board comprises steps of:
1) bonding the lower protective layer 3 to a bottom surface of the core board 1, then bonding the upper protective layer 4 to a top surface of the core board 1, and trimming edges of the upper protective layer 4 so that the edges of the upper protective layer 4 are flatly adhered to edges of the lower protective layer 3; and
2) arranging a concave portion 11 in a middle position of a top surface of the paddle board, and embedding a handle 2 in the concave portion 11 for carrying the paddle board; wherein a top opening of the handle 2 is flush with a surface of the upper protective layer 4.

The handle 2 is a rigid handle molded by injection molding of ABS plastic, APD plastic, nylon, or nylon blends; and a cavity, which is configured to be inserted with fingers, is provided in a middle of the handle 2. Specific compositions of the ABS plastic, APD plastic, nylon or nylon blends as well as specific operation processes of the injection molding are well known in the art, and will not be described here.

Continuous waveform concave portions 21, which fit the fingers, are arranged on two internal sides of the cavity of the handle 2 along a length direction of the paddle board. Sidewall concave portions 22, which are configured to be pressed against by bent fingers, are also provided on the internal sides of the cavity where the continuous waveform concave portions 21 locate; the sidewall concave portions 22 are topped by a slope surface 221 transitioning with the continuous waveform concave portions 21.

The handle 2 is box-shaped, and an external wall projection 25 enabling an interference fit between the handle 2 and the concave portion 11 is formed on an external wall of the handle 2; the external wall projection 25 is integrated with the handle 2 through injection molding. A convex rim 24 is provided on a top edge of the handle 2, and a top groove 12 for engaging with the convex rim 24 is formed at an opening of the concave portion 11.

Threaded holes 23 are provided at intervals on a bottom surface of the cavity of the handle 2, and threaded connection holes are provided on a bottom surface of the concave portion 11 corresponding to the threaded holes 23; the handle 2 and the core plate 1 are fixed together by screws.

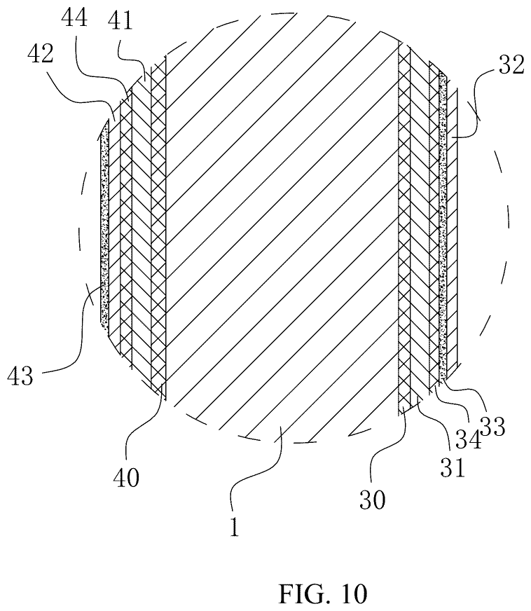

The method further comprising steps of:
a) forming the core board 1 by foaming a foam material in a core board mold with a desired shape, and leaving the concave portion 11 for embedding the handle 2 in a middle of the core board 1;
b) forming the lower protective layer 3 by making a lower substrate 31 with the foam material and affixing a transparent bottom sheet 32 on a bottom surface of the lower substrate 31 with an adhesive; and providing an internal pattern layer 33 on an internal surface of the transparent bottom sheet 32 through laser lining printing; wherein the adhesive is PE adhesive or other common adhesive; referring to FIG. 10, an adhesive layer indicated by reference characters 34 is a bottom adhesive layer; specific operation for producing the internal pattern layer 33 by laser lining printing is common in the art, and will not be described here; and
c) forming the upper protective layer 4 by making an upper substrate 41 with the foam material and affixing a top sheet 42 to a top surface of the upper substrate 41 with an adhesive; then providing a surface pattern layer 43 on an external surface of the top sheet 42 through laser surface printing; and leaving a notch in a middle of the upper protective layer 4 for embedding the handle 2; wherein a width of the notch is smaller than a width of an opening of the top groove 12; the upper protective layer 4 corresponding to the notch is sandwiched between the convex rim 24 and a bottom surface of the top groove 12; a top surface of the convex rim 24 is flush with a top surface of the upper protective layer 4 which is exposed outside the convex rim 24; the adhesive is PE adhesive or other common adhesive; referring to FIG. 10, an adhesive layer indicated by reference characters 44 is a top adhesive layer; specific operation for producing the surface pattern layer 43 by laser surface printing is common in the art, and will not be described here.

The lower protective layer 3 and the upper protective layer 4 are bonded to corresponding surfaces of the core board 1 by a hot-melt adhesive; a wooden stiffener 5 is embedded in the middle of the core board 1 along the length direction of the paddle board. Referring to FIG. 10, an upper hot melt adhesive layer is indicated by reference characters 40, and a lower hot melt adhesive layer is indicated by reference characters 30.

What is claimed is:

1. A method for making a paddle board, wherein the paddle board comprises an upper protective layer (4), a lower protective layer (3) and a core board (1); wherein the core board (1) is sandwiched between the upper protective layer (4) and lower protective layer (3); wherein the method comprises steps of:
1) bonding the lower protective layer (3) to a bottom surface of the core board (1), then bonding the upper protective layer (4) to a top surface of the core board (1), and trimming edges of the upper protective layer (4) so that the edges of the upper protective layer (4) are flatly adhered to edges of the lower protective layer (3); and
2) arranging a concave portion (11) in a middle position of a top surface of the paddle board, and embedding a handle (2) in the concave portion (11) for carrying the paddle board; wherein a top opening of the handle (2) is flush with a surface of the upper protective layer (4); the handle (2) is a rigid handle molded by injection molding of ABS plastic, APD plastic, nylon, or nylon blends; and a cavity, which is configured to be inserted with fingers, is provided in a middle of the handle (2).

2. The method, as recited in claim 1, wherein continuous waveform concave portions (21), which fit the fingers, are arranged on two internal sides of the cavity of the handle (2) along a length direction of the paddle board.

3. The method, as recited in claim 2, further comprising steps of:
a) forming the core board (1) by foaming a foam material in a core board mold with a desired shape, and leaving the concave portion (11) for embedding the handle (2) in a middle of the core board (1);
b) forming the lower protective layer (3) by making a lower substrate (31) with the foam material and affixing a transparent bottom sheet (32) on a bottom surface of the lower substrate (31) with an adhesive; and providing an internal pattern layer (33) on an internal surface of the transparent bottom sheet (32) through laser lining printing; and
c) forming the upper protective layer (4) by making an upper substrate (41) with the foam material and affixing a top sheet (42) to a top surface of the upper substrate (41) with an adhesive; then providing a surface pattern layer (43) on an external surface of the top sheet (42) through laser surface printing; and leaving a notch in a middle of the upper protective layer (4) for embedding the handle (2).

4. The method, as recited in claim 2, wherein sidewall concave portions (22), which are configured to be pressed against by bent fingers, are also provided on the internal sides of the cavity where the continuous waveform concave portions (21) locate; the sidewall concave portions (22) are topped by a slope surface (221) transitioning with the continuous waveform concave portions (21).

5. The method, as recited in claim 1, wherein the handle (2) is box-shaped, and an external wall projection (25) enabling an interference fit between the handle (2) and the concave portion (11) is formed on an external wall of the handle (2); the external wall projection (25) is integrated with the handle (2) through injection molding.

6. The method, as recited in claim 4, wherein the handle (2) is box-shaped, and an external wall projection (25) enabling an interference fit between the handle (2) and the concave portion (11) is formed on an external wall of the handle (2); the external wall projection (25) is integrated with the handle (2) through injection molding.

7. The method, as recited in claim 5, wherein a convex rim (24) is provided on a top edge of the handle (2), and a top groove (12) for engaging with the convex rim (24) is formed at an opening of the concave portion (11).

8. The method, as recited in claim 6, wherein a convex rim (24) is provided on a top edge of the handle (2), and a top groove (12) for engaging with the convex rim (24) is formed at an opening of the concave portion (11).

9. The method, as recited in claim 7, wherein a width of the notch is smaller than a width of an opening of the top groove (12); the upper protective layer (4) corresponding to the notch is sandwiched between the convex rim (24) and a bottom surface of the top groove (12).

10. The method, as recited in claim 8, wherein a width of the notch is smaller than a width of an opening of the top groove (12); the upper protective layer (4) corresponding to the notch is sandwiched between the convex rim (24) and a bottom surface of the top groove (12).

11. The method, as recited in claim 9, wherein a top surface of the convex rim (24) is flush with a top surface of the upper protective layer (4) which is exposed outside the convex rim (24).

12. The method, as recited in claim 10, wherein a top surface of the convex rim (24) is flush with a top surface of the upper protective layer (4) which is exposed outside the convex rim (24).

13. The method, as recited in claim 1, wherein threaded holes (23) are provided at intervals on a bottom surface of the cavity of the handle (2), and threaded connection holes are provided on a bottom surface of the concave portion (11) corresponding to the threaded holes (23); the handle (2) and the core plate (1) are fixed together by screws.

14. The method, as recited in claim 2, wherein threaded holes (23) are provided at intervals on a bottom surface of the cavity of the handle (2), and threaded connection holes are provided on a bottom surface of the concave portion (11) corresponding to the threaded holes (23); the handle (2) and the core plate (1) are fixed together by screws.

15. The method, as recited in claim 3, wherein threaded holes (23) are provided at intervals on a bottom surface of the cavity of the handle (2), and threaded connection holes are provided on a bottom surface of the concave portion (11) corresponding to the threaded holes (23); the handle (2) and the core plate (1) are fixed together by screws.

16. The method, as recited in claim 4, wherein threaded holes (23) are provided at intervals on a bottom surface of the cavity of the handle (2), and threaded connection holes are provided on a bottom surface of the concave portion (11) corresponding to the threaded holes (23); the handle (2) and the core plate (1) are fixed together by screws.

17. The method, as recited in claim 1, wherein the lower protective layer (3) and the upper protective layer (4) are bonded to corresponding surfaces of the core board (1) by a hot-melt adhesive; a wooden stiffener (5) is embedded in a middle of the core board (1) along a length direction of the paddle board.

18. The method, as recited in claim 2, wherein the lower protective layer (3) and the upper protective layer (4) are bonded to corresponding surfaces of the core board (1) by a hot-melt adhesive; a wooden stiffener (5) is embedded in a middle of the core board (1) along the length direction of the paddle board.

19. The method, as recited in claim 3, wherein the lower protective layer (3) and the upper protective layer (4) are bonded to corresponding surfaces of the core board (1) by a hot-melt adhesive; a wooden stiffener (5) is embedded in the middle of the core board (1) along the length direction of the paddle board.
